(19) United States
(12) Patent Application Publication
(10) Pub. No.: US 2008/0174224 A1
(43) Pub. Date: Jul. 24, 2008

(54) Lamp head structure

(75) Inventors: Jui-Tsung Liao, San Chung City (TW); Tai-Ho Huang, San Chung City (TW); Tung-Ching Wu, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 11/727,189

(22) Filed: Mar. 23, 2007

(30) Foreign Application Priority Data
Jan. 24, 2007 (TW) 096201375

(51) Int. Cl. H01J 5/50

(52) U.S. Cl. 313/318.01

(57) ABSTRACT

A lamp head structure comprises a base and a circuit board. The base has an opening on the bottom and an open slot on at least one side. The circuit board has a respective electrically conducting layer on the bottom surface and at least one lateral surface. The circuit board is located inside the open slot of the base. The electrically conducting layer on the bottom surface of the circuit board is located corresponding to the opening on the bottom of the base. At least one light-emitting device is coupled to the circuit board. A positive electrode and a negative electrode of the light-emitting device are connected to the circuit board. The circuit board is coupled to the base to effectively simplify manufacture process and allow convenient repair.

### FIELD OF THE INVENTION

The present invention relates to a lamp head structure that effectively simplifies manufacture process and facilitates repair to be suitable for use in an illumination device such as a light bulb, a LED lamp or the like.

### BACKGROUND OF THE INVENTION

As shown in FIG. 4, the conventional lamp bulb is formed by coupling a lamp cap 81 to an open end of a vacuumed lamp housing 80, wherein the lamp cap 81 is designed for coupling to a lamp holder. The lamp housing 80 has mounted thereinside a stem structure 82 made of an insulating material such as glass. A cap portion 820 is formed on the top of the stem structure 82. The cap portion 820 has three raised arms 85 mounted thereon to allow insertion of two magnesium-plated filaments 831, 832 into the stem structure 82 in a perpendicular direction. Thereafter, a tungsten filament 84 is utilized to wind these two filaments 831, 832 and the raised arms 85.

The foregoing stem structure 82 is made of a glass material. In the conventional manufacture process, the stem structure 82 and the lamp housing 80 are made separately from each other. During the assembly process, the stem structure 82 is inserted into the lamp housing 80 via its bottom opening. Next, they are melted to combine with each other by heating the junction therebetween. Next, the polar leads are dragged out of the periphery and the bottom of the lamp cap 81 to form positive and negative electrodes. If the manufactured lamp bulb is a defective product after testing, the lamp bulb must be detached before recognizing the problem. As a result, it is time and labor consuming, and such a conventional structure is not ideal enough.

In view of this, the present inventor makes diligent studies in providing general public with a lamp head structure that may have any shape.

### SUMMARY OF THE INVENTION

It is a major object of the present invention to provide a lamp head structure that effectively simplifies manufacture process and facilitates repair.

In order to achieve the foregoing object, a lamp head structure of the present invention is comprised of a base and a circuit board. The base has an opening on the bottom and an open slot on at least one side. The circuit board has a respective electrically conducting layer on the bottom surface and at least one lateral surface. The circuit board is located inside the open -slot of the base. The electrically conducting layer on the bottom surface of the circuit board is located corresponding to the opening on the bottom of the base. At least one light-emitting device is coupled to the circuit board. A positive electrode and a negative electrode of the light-emitting device are connected to the circuit board. The circuit board is coupled to the base to effectively simplify manufacture process and allow convenient repair.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is a decomposed view showing the components of the first preferred embodiment the present invention.

FIG. 3 is an elevational view showing a second preferred embodiment of the present invention.

FIG. 4 is an elevational view showing a conventional structure.

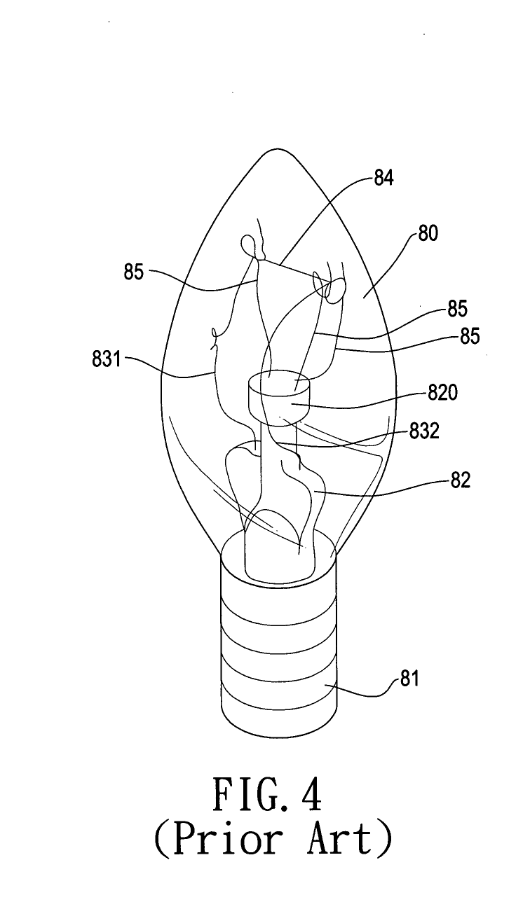

### DETAILED DESCRIPTION OF THE PREFERRED EMBODIMENT

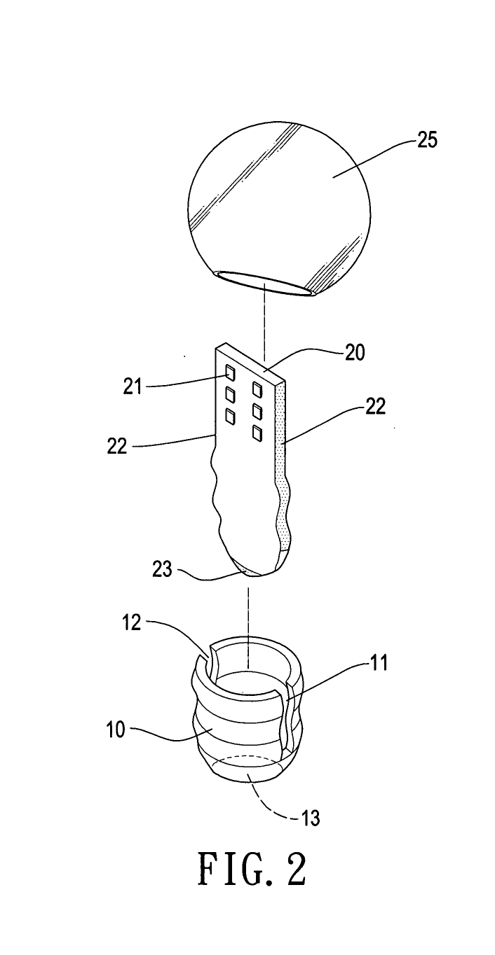

Referring to FIG. 2, a lamp head structure of the present invention generally comprises a base 10 and a circuit board 20, wherein the base 10 is a short tube having a thread on the outer surface and it is made by plastic injection-molding or made of an electrically nonconducting metal material. The base 10 has an opening 13 on the bottom and at least one open slot 11 on the periphery, wherein two open slots 11, 12, which are opposite to each other, are formed in this preferred embodiment.

The circuit board 20 has a width complying with the base 10. The circuit board 20 has at least one light-emitting device coupled thereto. In this preferred embodiment, there are plural light-emitting diodes 21 coupled to the front surface and the back surface of the circuit board 20. Moreover, two lateral surfaces (or at least one lateral surface) and a bottom surface of the circuit board 20 are coated with a respective electrically conducting layer. The electrically conducting layer on these two lateral surfaces and the electrically conducting layer on the bottom surface are separated and disconnected from one other in such a manner that these two lateral surfaces of the circuit board 20 form two polar lateral surfaces (positive electrodes) 22 and the bottom surface of the circuit board 20 forms a polar bottom surface (negative electrode) 23. In addition, the positive electrodes of the light-emitting diodes 21 are all connected to the polar lateral surfaces (positive electrodes) 22, and the negative electrodes of the light-emitting diodes 21 are all connected to the polar bottom surface (negative electrode) 23 so that the positive and negative electrodes of the light-emitting diodes 21 are connected to the adjacent polar lateral surfaces (positive electrodes) 22 and the polar bottom surface (negative electrode) 23, respectively. In addition, a lampshade 25 is located over the top of the base 10 to protect the circuit board 20.

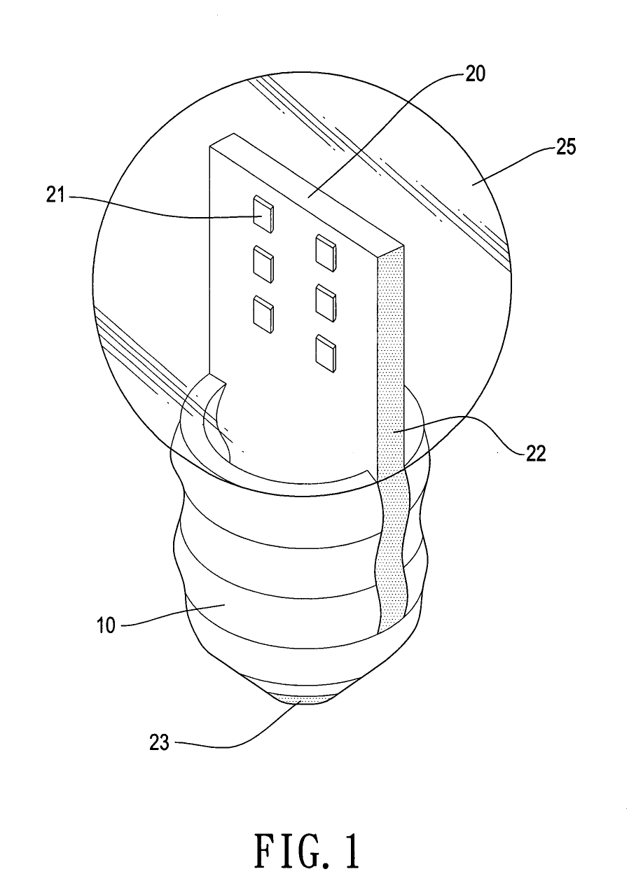

The circuit board 20 can be inserted into the base 10 by inserting the polar bottom surface (negative electrode) 23 into the base 10 in a downward direction and aiming the polar lateral surfaces (positive electrodes) 22 at the open slots 11, 12 of the base 10 so as to couple the circuit board 20 to the inside of the base 10 directly by adhesion, hooking and so forth for exposing the polar bottom surface (negative electrode) 23 and the polar lateral surfaces (positive electrodes) 22 of the light-emitting diodes 21 to outside via the opening 13 and the open slots 11, 12 of the base 10. In addition, the lampshade 25 is coupled to the base 10 to form a unity after covering the top of the circuit board 20, as shown in FIG. 1, thereby completing the assembly of the lamp head structure.

During testing of the foregoing assembled lamp head structure, the base 10 only needs to be coupled to the inside of an electrified lamp holder so as to electrify the polar lateral surfaces 22 and the polar bottom surface 23 of the circuit board 20, thereby allowing the light-emitting diodes 21 mounted on the circuit board 20 to generate a lighting effect. If the light-emitting diodes 21 do not generate the lighting effect after electrification, the circuit board 20 only needs to be detached from the base 10 for repair, thereby causing much convenience.

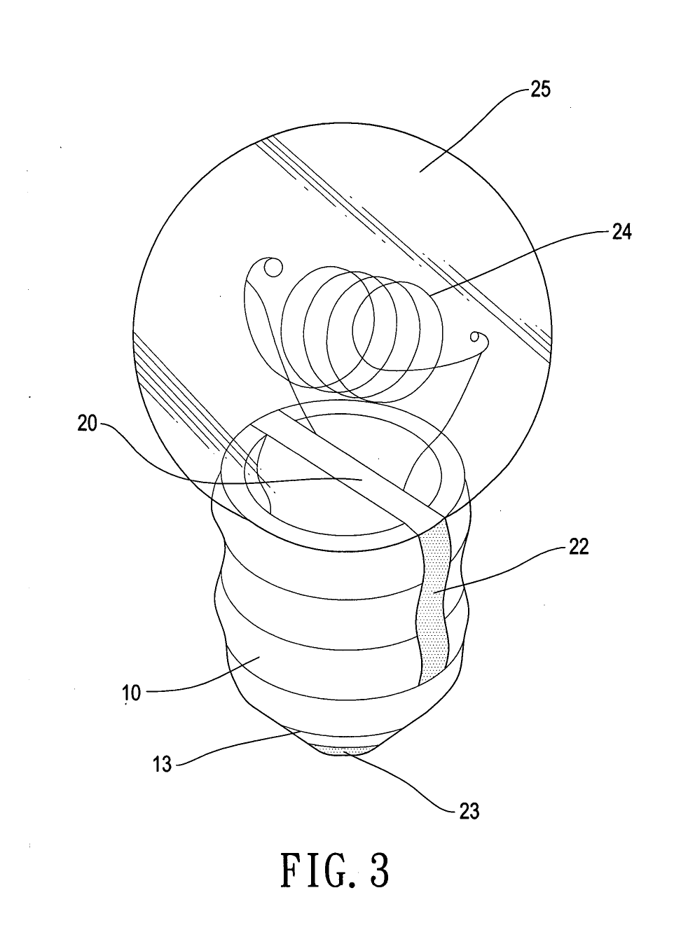

Furthermore, as shown in FIG. 3, the light-emitting device that couples to circuit board 20 may be a conventional tungsten filament lamp bulb 24. These two lateral surfaces and the bottom surface of the circuit board 20 are all coated with a respective electrically conducting layer. The electrically conducting layers on the lateral surfaces and the electrically conducting layer on the bottom surface are separated and disconnected from one other in such a manner that the lateral surfaces of the circuit board 20 form two polar lateral surfaces (positive electrodes) 22 and the bottom surface of the circuit board 20 forms a polar bottom surface (negative electrode) 23. In addition, the positive electrode of the tungsten filament lamp bulb 24 is connected to the polar lateral surfaces (positive electrodes) 22, and the negative electrode of the tungsten filament lamp bulb 24 is connected to the polar bottom surface (negative electrode) 23. In addition, the tungsten filament lamp bulb 24 is covered with a lampshade 25 for protection. As a result, the positive and negative electrodes of the tungsten filament lamp bulb 24 can be exposed outside of the both sides and the bottom of the base 10 by merely coupling the circuit board 20 to the base 10.

In accordance with the foregoing description, the present invention has the following practical advantages:

1. The manufacture process of the conventional lamp bulb can be simplified effectively by the use of simple components, which are easily and simply coupled together.

2. If a defective product is found during testing, the circuit board only needs to be detached from the base to facilitate the repair of the circuit of the circuit board or the repair of the base.

3. The base does not require an electrically conducting metal material, and it is made merely by plastic injection-molding or made of an electrically nonconducting metal material, causing the significant reduction of production cost.

To sum up, the lamp head structure of the present invention is capable of achieving the anticipated objects described above. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A lamp head structure, comprising:
a base having an opening on the bottom and an open slot on at least one side; and
a circuit board having a respective electrically conducting layer on a bottom surface and at least one lateral surface, said circuit board being located inside said open slot of said base, said electrically conducting layer on said bottom surface of said circuit board being located corresponding to said opening on the bottom of said base, said circuit board further having at least one light-emitting device coupled thereto, said at least one light-emitting device having a positive electrode and a negative electrode connected to said circuit board, thereby effectively simplifying manufacture process and allowing convenient repair by coupling said circuit board to said base.

2. A lamp head structure according to claim 1, wherein said at least one light-emitting device that couples to said circuit board is a tungsten filament lamp bulb.

3. A lamp head structure according to claim 1, wherein said at least one light-emitting device that couples to said circuit board is a light-emitting diode.

4. A lamp head structure according to claim 1, wherein said base is further covered with a cover for protecting said at least one light-emitting diode.

5. A lamp head structure according to claim 1, wherein said base is made of an electrically nonconducting metal material.

6. A lamp head structure according to claim 1, wherein said base is made of a plastic material.
